(19) United States
(12) Patent Application Publication
(10) Pub. No.: US 2009/0062157 A1
(43) Pub. Date: Mar. 5, 2009

(54) Methods and compositions related to the degradation of degradable polymers involving dehydrated salts and other associated methods

(75) Inventors: Trinidad Munoz, JR., Duncan, OK (US); Bradley L. Todd, Duncan, OK (US)

Correspondence Address: ROBERT A. KENT, P.O. BOX 1431, DUNCAN, OK, 73536, US

(73) Assignee: Halliburton Energy Services, Inc.

(21) Appl. No.: 11/897,296

(22) Filed: Aug. 30, 2007

(51) Int. Cl. C09K 8/035

(52) U.S. Cl. 507/219

(57) ABSTRACT

Methods are included herein that include a method comprising: providing a degradable particulate comprising a degradable polymer matrix and an dehydrated salt; and placing the degradable particulate in a subterranean formation. Other methods and compositions are provided as well.

### BACKGROUND

The present invention relates generally to facilitating the use of degradable polymers. More particularly, the present invention relates to compositions and methods for controlling the degradation of degradable polymers, and methods related to the use of such degradable polymers, for example, in subterranean applications.

Degradable particulates often comprise degradable polymers that are capable of undergoing an irreversible degradation when used in subterranean applications, e.g., in a well bore. As used herein, the terms “particulate” or “particulates” refer to a particle or particles that may have a physical shape of platelets, shavings, fibers, flakes, ribbons, rods, strips, spheroids, toroids, pellets, tablets, or any other suitable shape. The term “irreversible” as used herein means that the degradable material should degrade in situ (e.g., within a well bore), but should not recrystallize or reconsolidate in situ after degradation (e.g., in a well bore). The terms “degradation” or “degradable” refer to both the two relatively extreme cases of hydrolytic degradation that the degradable material may undergo, e.g., heterogeneous (or bulk erosion) and homogeneous (or surface erosion), and any stage of degradation in between these two. This degradation can be a result of, inter alia, a chemical or thermal reaction, or a reaction induced by radiation. The terms “polymer” or “polymers” as used herein do not imply any particular degree of polymerization; for instance, oligomers are encompassed within this definition as are copolymers, terpolymers, etc.

The degradability of a degradable polymer often depends, at least in part, on its backbone structure. For instance, the presence of hydrolyzable and/or oxidizable linkages in the backbone often yields a material that will degrade as described herein. The rates at which such polymers degrade may be dependent on the type of repetitive unit, composition, sequence, length, molecular geometry, molecular weight, morphology (e.g., crystallinity, size of spherulites, and orientation), hydrophilicity, hydrophobicity, surface area, and additives. Also, the environment to which the polymer is subjected may affect how it degrades, e.g., temperature, presence of moisture, oxygen, microorganisms, enzymes, pH, and the like.

The physical properties of degradable polymers depend on several factors such as the composition of the repeat units, flexibility of the chain, presence of polar groups, molecular mass, degree of branching, crystallinity, orientation, etc. For example, short chain branches reduce the degree of crystallinity of polymers while long chain branches lower the melt viscosity and impart, inter alia, extensional viscosity with tension-stiffening behavior. The properties of the material utilized can be further tailored by blending, and copolymerizing it with another polymer, or by changing the macromolecular architecture (e.g., hyper-branched polymers, star-shaped, or dendrimers, etc.). The properties of any such suitable degradable polymers (e.g., hydrophobicity, hydrophilicity, rate of degradation, etc.) can be tailored by introducing select functional groups along the polymer chains. For example, poly(phenyllactide) will degrade at about one fifth of the rate of racemic poly(lactide) at a pH of 7.4 at 55° C.

To obtain degradable particulates that may be used in subterranean applications (e.g., as acid precursors, fluid loss control particles, diverting agents, filter cake components, drilling fluid additives, cement additives, etc.), off-site processes may be used wherein the degradable particulates are manufactured and then those particulates are transported to a drill site for use. Common manufacturing processes include cryogenic grinding, which is an expensive process that involves grinding a degradable polymer, such as poly(lactic acid), at cryogenic temperatures to form particulates having a desired shape and size. Another method that may be used to make degradable particulates off-site is spray drying. Spray drying processes usually involve dissolution of a degradable polymer sample in a volatile solvent (which can be an environmental problem itself), and spraying the solution into a stream of hot gas to make degradable particulates. Another method of producing degradable particulates is an extrusion method; however, extrusion methods generally are not useful for making degradable particulates that are less than about 500 microns in size. Another method may involve emulsion techniques. High shear grinding is another example.

Oftentimes, the degradable polymers used when they degrade release an acid. For instance, polylactic acid is used as a delayed release acid in a variety of applications. Polylactic acid slowly hydrolyzes at elevated temperatures to yield lactic acid, which is readily soluble in water. In some instances, the polylactic acid may degrade too quickly, for instance, in a drill-in fluid or in a fluid loss control pill. Thus, although the degradation products of these polymers may be useful in certain circumstances (e.g., to break a fluid), sometimes there is a need to delay the hydrolysis of the degradable polymers for an extended period of time at elevated temperatures. Although the rate of hydrolysis can be affected by the level of crystallinity, the presence of certain monomers, and by molecular weight, there remains a need for a means to control the degradation of the polymers that can be included in the polymer matrix to delay the degradation of the polymer.

### SUMMARY

The present invention relates generally to facilitating the use of degradable polymers. More particularly, the present invention relates to compositions and methods for controlling the degradation of degradable polymers, and methods related to the use of such degradable polymers, for example, in subterranean applications.

In some embodiments, the present invention provides methods that include a method comprising: providing a degradable particulate comprising a degradable polymer matrix and a dehydrated salt; and placing the degradable particulate in a subterranean formation.

In some embodiments, the present invention provides methods that include a method comprising: providing a treatment fluid at a drill site, the treatment fluid comprising at least a plurality of degradable particulates, at least one of the degradable particulates comprising a degradable polymer matrix and a dehydrated salt; and introducing the treatment fluid into a well bore penetrating a subterranean formation at the drill site.

In some embodiments, the present invention provides methods that include a method of controlling the degradation of a degradable polymer matrix comprising: providing at least a plurality of degradable particulates, at least one of which comprising a degradable polymer matrix comprising a degradable polymer and having a first degradation rate; incorporating a dehydrated salt into the degradable polymer matrix; and allowing the salt to interact with a water source neighboring the degradable polymer matrix in such a manner as to allow the degradable polymer matrix to degrade at a second degradation rate that is slower than the first degradation rate of the degradable particulate.

In another embodiment, the present invention provides a degradable particulate for use in a subterranean formation comprising a degradable polymer matrix and a dehydrated salt.

The features and advantages of the present invention will be readily apparent to those skilled in the art. While numerous changes may be made by those skilled in the art, such changes are within the spirit of the invention.

### DESCRIPTION OF PREFERRED EMBODIMENTS

The present invention relates generally to facilitating the use of degradable polymers. More particularly, the present invention relates to compositions and methods for controlling the degradation of degradable polymers, and methods related to the use of such degradable polymers, for example, in subterranean applications.

The present invention provides compositions and methods that relate to controlling the degradation of degradable polymers by incorporating dehydrated salts into the polymer matrix of the degradable polymers. One of the many advantages of the invention is that the dehydrated salts may be incorporated into the polymer matrix during melt processing of the degradable polymers at a desired concentration level. Although not wanting to be limited to any particular theory, it is believed that the dehydrated salts may affect the hydrolyzation of the degradable polymer be reacting with the water surrounding the degradable polymer in an aqueous environment so that the water cannot react with the degradable polymer. In effect, it is believed the dehydrated salts tie up the water molecules so that they cannot react with the degradable polymer to hydrolyze the polymer. The believed net effect is a delay of the degradation of the degradable polymer. As described herein, the term degradable particulate refers to a degradable polymer matrix comprising a dehydrated salt. The term “matrix” as used herein refers to a degradable continuous phase in which the dehydrated salt particles are embedded as a discontinuous phase. However, no degree of embeddedness is implied by the term.

In some embodiments, the present invention provides methods that include a method of controlling the degradation of a degradable polymer matrix comprising: providing a degradable polymer matrix having a first degradation rate; incorporating a dehydrated salt into the degradable polymer matrix; and allowing the salt to interact with a water source neighboring the polymer matrix in such a manner as to allow the degradable polymer matrix to degrade at a second degradation rate that is slower than the first degradation rate.

The degradable particulates made in conjunction with a method of the present invention can be placed into a subterranean formation with or without a treatment fluid, or they may be stored in a suitable collection container located at or near the drill site for use at a desired time, depending on the storability of the particulates. As used herein, the term “treatment fluid” refers to any fluid that may be used in a subterranean application in conjunction with a desired function and/or for a desired purpose. The term “treatment fluid” does not imply any particular action by the fluid or any component thereof. In some embodiments, a particular treatment fluid with which the degradable particulates will be placed into a well bore may be incorporated into a method of making the degradable particulates, e.g., as a solvent or fluid in the process. The degradable particulates may have differing properties, such as, relative hardness, pliability, degradation rate, etc. depending on the processing factors, the type of degradable polymer used, etc. The specific properties of the degradable particulates produced may vary by varying certain process parameters (including compositions), which will be evident to one of ordinary skill in the art with the benefit of this disclosure.

Examples of suitable degradable polymers that may be used in conjunction with this invention include, but are not limited to, aliphatic polyesters; poly(lactides); poly(glycolides); poly(ε-caprolactones); poly(hydroxy ester ethers); poly(hydroxybutyrates); poly(anhydrides); polycarbonates; poly(orthoesters) (sometimes referred to as poly(ortho ethers)); poly(amino acids); poly(ethylene oxides); poly(phosphazenes); poly ether esters, polyester amides, polyamides, and copolymers or blends of any of these degradable polymers. The term “copolymer” as used herein is not limited to the combination of two polymers, but includes any combination of polymers, e.g., terpolymers and the like. Of these suitable polymers, aliphatic polyesters such as poly(lactic acid), poly(anhydrides), poly(orthoesters), and poly(lactide)-co-poly(glycolide) copolymers are preferred. Poly(lactic acid) is especially preferred. Poly(orthoesters) also may be preferred. Other degradable polymers that are subject to hydrolytic degradation also may be suitable. One's choice may depend on the particular application and the conditions involved. Other guidelines to consider include the degradation products that result, the time required for the requisite degree of degradation, and the desired result of the degradation (e.g., voids). Others that are preferred include those degradable polymers that release useful or desirable degradation products that are desirable, e.g., an acid. Such degradation products may be useful in a downhole application, e.g., to break a viscosified treatment fluid or an acid soluble component present therein (such as in a filter cake). The amount of degradable polymer used may vary with the application for which it will be used. For instance, if the degradable polymers are used to lower the pH, then only enough will be added to react with any buffers (if present) and to take the pH to the desired level. This might be used in an application such as uncrosslinking a borate crosslinked polymer. In another instance, to generate enough acid to actually degrade a polymer, about 0.1% to about 5% by weight of the entire system may be used. In another instance, for example, to remove a calcium carbonate filter cake, about 3 to about 20% by weight of the entire system may be used. Another example includes where the degradable polymer is used to formulate an inside the screen pill, in which a concentration of about 10 to about 70% might be used. One of ordinary skill in the art with the benefit of this disclosure will recognize the appropriate amount to use for a given application.

Preferred aliphatic polyesters have the general formula of repeating units shown below:

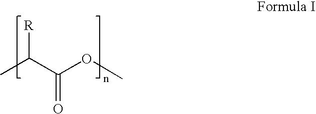

where n is an integer between 75 and 10,000 and R is a hydrogen, alkyl, aryl, alkylaryl, acetyl, heteroatoms, or mixtures thereof. Of these aliphatic polyesters, poly(lactide) is preferred. Poly(lactide) is synthesized either from lactic acid by a condensation reaction or more commonly by ring-opening polymerization of cyclic lactide monomer. Since both lactic acid and lactide can achieve the same repeating unit, the general term poly(lactic acid) as used herein refers to formula I without any limitation as to how the polymer was made such as from lactides, lactic acid, or oligomers, and without reference to the degree of polymerization or level of plasticization. The lactide monomer exists generally in three different forms: two stereoisomers L- and D-lactide and racemic D,L-lactide (meso-lactide). The oligomers of lactic acid, and oligomers of lactide are defined by the formula:

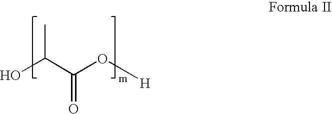

where m is an integer 2≦m≦75. Preferably m is an integer and 2≦m≦10. These limits correspond to number average molecular weights below about 5,400 and below about 720, respectively. The chirality of the lactide units provides a means to adjust, inter alia, degradation rates, as well as physical and mechanical properties. Poly(L-lactide), for instance, is a semicrystalline polymer with a relatively slow hydrolysis rate. This could be desirable in applications of the present invention where a slower degradation of the degradable particulates is desired. Poly(D,L-lactide) may be a more amorphous polymer with a resultant faster hydrolysis rate. This may be suitable for other applications where a more rapid degradation may be appropriate. The stereoisomers of lactic acid may be used individually or combined to be used in accordance with the present invention. Additionally, they may be copolymerized with, for example, glycolide or other monomers like ε-caprolactone, 1,5-dioxepan-2-one, trimethylene carbonate, or other suitable monomers to obtain polymers with different properties or degradation times. Additionally, the lactic acid stereoisomers can be modified to be used in the present invention by, inter alia, blending, copolymerizing or otherwise mixing the stereoisomers, blending, copolymerizing or otherwise mixing high and low molecular weight poly(lactides), or by blending, copolymerizing or otherwise mixing a poly(lactide) with another polyester or polyesters.

Plasticizers may be included in the degradable polymers of the present invention. The plasticizers may be present in an amount sufficient to provide the desired characteristics, for example, a desired tackiness to the generated degradable particulates. In addition to the other qualities above, the plasticizers may enhance the degradation rate of the degradable polymeric materials. The plasticizers, if used, are preferably at least intimately incorporated within the degradable polymer matrixes. An example of a suitable plasticizer for poly(lactide) would include oligomeric lactic acid. Examples of plasticizers useful for this invention include, but are not limited to, polyethylene glycol; polyethylene oxide; oligomeric lactic acid; citrate esters (such as tributyl citrate oligomers, triethyl citrate, acetyltributyl citrate, and acetyltriethyl citrate); glucose monoesters; partially fatty acid esters; PEG monolaurate; triacetin; poly(e-caprolactone); poly(hydroxybutyrate); glycerin-1-benzoate-2,3-dilaurate; glycerin-2-benzoate-1,3-dilaurate; bis(butyl diethylene glycol)adipate; ethylphthalylethyl glycolate; glycerin diacetate monocaprylate; diacetyl monoacyl glycerol; polypropylene glycol (and epoxy derivatives thereof); poly(propylene glycol)dibenzoate, dipropylene glycol dibenzoate; glycerol; ethyl phthalyl ethyl glycolate; poly(ethylene adipate)distearate; di-iso-butyl adipate; and combinations thereof. The choice of an appropriate plasticizer will depend on the particular degradable polymer utilized. It should be noted that, in certain embodiments, when initially formed, the degradable particulates may be somewhat pliable. But once substantially all of the solvent has been removed, the particulates should harden. More pliable degradable particulates may be beneficial in certain chosen applications. The presence of a plasticizer can affect the relative degree of pliability. Also, the relative degree of crystallinity and amorphousness of the degradable polymer can affect the relative hardness of the degradable particulates.

A dehydrated salt is suitable for use in the present invention if it will degrade over time as it hydrates. For example, a particulate solid anhydrous borate material that degrades over time may be suitable. Specific examples of particulate solid anhydrous borate materials that may be used include, but are not limited to, anhydrous sodium tetraborate (also known as anhydrous borax), and anhydrous boric acid. Combinations of these may be suitable. These anhydrous borate materials are only slightly soluble in water. However, with time and heat in a subterranean environment, the anhydrous borate materials react with the surrounding aqueous fluid and are hydrated. The resulting hydrated borate materials are highly soluble in water as compared to anhydrous borate materials and as a result degrade in the aqueous fluid. In some instances, the total time required for the anhydrous borate materials to degrade in an aqueous fluid is in the range of from about 8 hours to about 72 hours depending upon the temperature of the subterranean zone in which they are placed.

The degradable particulates of the present invention may be produced by any suitable method. One example of a method is a melt coagulation method. An example of a melt coagulation method comprises the steps of providing a degradable polymer melt that comprises a dehydrated salt; atomizing the degradable polymer melt into an atomization fluid stream; and allowing degradable particulates to form that comprise a dehydrated salt.

These methods of generating degradable particulates may be used at a drill site. The term drill site, as used herein, refers to the workplace at the site of a drill hole (sometimes referred to as a well bore or borehole) before, during, and after production. The degradable particulates can be made at the drill site for use in a well bore located at the drill site. In certain embodiments, the degradable particulates may be made and then stored at the drill site until a desired time for use. In other embodiments of this invention, the degradable particulates can be made at the drill site and then used relatively quickly in a chosen subterranean application. The storability of the degradable particulates made, and the particular application in which they will be used, likely will dictate whether storage or immediate use is preferred. One of the many advantages offered by the methods and compositions of the present invention is the ability to modify the degradable particulates to respond to changes in conditions and requirements. For instance, the particle size distribution or relative pliability could be modified based on the particular subterranean conditions encountered. Another advantage is that transportation costs and conditions that may harm the degradable particulates may be avoided and/or reduced. Examples of subterranean applications in which the generated degradable particulates could be used include, but are not limited to, such applications as fluid loss control particles, as diverting agents, as filter cake components, as drilling fluid additives, as cement composition additives, or other acid-precursor components.

The degradable particulates can be used in a subterranean application with or without a treatment fluid, depending on the particular application and the surrounding circumstances. One of ordinary skill in the art with the benefit of this disclosure will be able to recognize when the degradable particulates should be or should not be used in conjunction with a treatment fluid. One consideration is the ability to incorporate the degradable particulates in the treatment fluid. Another consideration is the timing desired for the degradation of the degradable particulates. Another consideration is the concentration of degradable particulates needed in a chosen treatment fluid.

The degradable particulates made by any method of this invention may be used in any suitable subterranean application. Depending on the particular use, the degradable particulates may have several purposes. The first is to create voids upon degradation. A second is to release certain desirable degradation products that may then be useful for a particular function. Another reason is to temporarily restrict the flow of a fluid. Examples of subterranean applications in which the generated degradable particulates could be used include, but are not limited to, such applications as fluid loss control particles, as diverting agents, as filter cake components, as drilling fluid additives, as cement composition additives, or other acid-precursor components. Specific nonlimiting embodiments of some examples are discussed below.

In some methods, the degradable particulates may be used to increase the conductivity of a fracture. This may be accomplished by incorporating the degradable particulates into a fracturing fluid comprising proppant particulates, allowing the proppant particulates to form a proppant matrix within a fracture that comprises the degradable particulates, and allowing the degradable particulates to degrade to form voids within the proppant matrix. The term “proppant matrix” refers to some consolidation of proppant particulates.

In another example of a subterranean application, the degradable particulates may be used to divert a fluid within a subterranean formation.

In another example, the degradable particulates may be used in a composition designed to provide some degree of sand control to a portion of a subterranean formation. In an example of such a method, the degradable particulates may be incorporated into a cement composition which is placed down hole in a manner so as to provide some degree of sand control. An example of such a cement composition comprises a hydraulic cement, sufficient water to form a pumpable slurry, and the degradable particulates formed by a method of this invention. Optionally, other additives used in cementing compositions may be added.

In another example, the degradable particulates may be incorporated into a cement composition to be used in a primary cementing operation, such as cementing casing in a well bore penetrating a subterranean formation. An example of such a cement composition comprises a hydraulic cement, sufficient water to form a pumpable slurry, and the degradable particulates formed by a method of this invention. Optionally, other additives used in cementing compositions may be added.

In another example, the degradable particulates may be incorporated in a gravel pack composition. Upon degradation of the degradable particulates, any acid-based degradation products may be used to degrade an acid-soluble component in the subterranean formation, including but not limited to a portion of a filter cake situated therein.

In another example, the degradable particulates may be incorporated with a viscosified treatment fluid (e.g., a fracturing fluid or a gravel pack fluid) to act as a breaker for the viscosified treatment fluid (i.e., at least partially reduce the viscosity of the viscosified treatment fluid).

In another example, the degradable particulates may be used as self-degrading bridging agents in a filter cake.

In another example, the degradable particulates may be used as a fluid loss control additive for at least partially controlling or minimizing fluid loss during a subterranean treatment such as fracturing.

In another example, the degradable particulates may be used in conjunction with cleaning or cutting a surface in a subterranean formation, such as in a fluid jetting operation to cut an opening in a casing or remove a deposit from a surface.

In some embodiments, the present invention provides methods that include a method comprising: providing a degradable particulate comprising a degradable polymer matrix and a dehydrated salt; and placing the degradable particulate in a subterranean formation.

In some embodiments, the present invention provides methods that include a method comprising: providing a treatment fluid at a drill site, the treatment fluid comprising at least a plurality of degradable particulates, at least one of the degradable particulates comprising a degradable polymer matrix and a dehydrated salt; and introducing the treatment fluid into a well bore penetrating a subterranean formation at the drill site.

In some embodiments, the present invention provides methods that include a method of controlling the degradation of a degradable polymer matrix comprising: providing at least a plurality of degradable particulates, at least one of which comprising a degradable polymer matrix comprising a degradable polymer and having a first degradation rate; incorporating a dehydrated salt into the degradable polymer matrix; and allowing the salt to interact with a water source neighboring the degradable polymer matrix in such a manner as to allow the degradable polymer matrix to degrade at a second degradation rate that is slower than the first degradation rate of the degradable particulate.

In another embodiment, the present invention provides a degradable particulate for use in a subterranean formation comprising a degradable polymer matrix and a dehydrated salt.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. In particular, every range of values (of the form, “from about a to about b,” or, equivalently, “from approximately a to b,” or, equivalently, “from approximately a-b”) disclosed herein is to be understood as referring to the power set (the set of all subsets) of the respective range of values, and set forth every range encompassed within the broader range of values. Moreover, the indefinite articles “a” or “an”, as used in the claims, are defined herein to mean one or more than one of the element that it introduces. Also, the terms in the claims have their plain, ordinary meaning unless otherwise explicitly and clearly defined by the patentee.

What is claimed is:

1. A method comprising:
providing a degradable particulate comprising a degradable polymer matrix and a dehydrated salt; and
placing the degradable particulate in a subterranean formation.

2. The method of claim 1 wherein the degradable polymer matrix comprises a degradable polymer chosen from the group consisting of: an aliphatic polyester; a poly(lactide); a poly(glycolide); a poly(ε-caprolactone); a poly(hydroxy ester ether); a poly(hydroxybutyrate); a poly(anhydride); a polycarbonate; a poly(orthoester); a poly(amino acid); a poly(ethylene oxide); a poly(phosphazene); a poly ether ester; a polyester amides; a polyamide; and copolymers or blends of any of these degradable polymers.

3. The method of claim 1 wherein the degradable polymer matrix comprises a plasticizer.

4. The method of claim 1 wherein the dehydrated salt comprises a dehydrated salt chosen from the group consisting of: a particulate solid anhydrous borate material; anhydrous sodium tetraborate; anhydrous boric acid; and combinations thereof.

5. The method of claim 1 wherein the degradable particulate is made by a melt coagulation method.

6. The method of claim 1 wherein the degradable particulate are made at the drill site.

7. The method of claim 1 wherein the degradable particulate is placed in the subterranean formation for use as a fluid loss control particle, a diverting agent, a filter cake component, a drilling fluid additive, a cement composition additive, a fracturing fluid additive, a gravel pack additive, or an acid-precursor component.

8. A method comprising:
providing a treatment fluid at a drill site, the treatment fluid comprising at least a plurality of degradable particulates, at least one of the degradable particulates comprising a degradable polymer matrix and a dehydrated salt; and
introducing the treatment fluid into a well bore penetrating a subterranean formation at the drill site.

9. The method of claim 8 wherein the degradable polymer matrix comprises a degradable polymer chosen from the group consisting of: an aliphatic polyester; a poly(lactide); a poly(glycolide); a poly(ε-caprolactone); a poly(hydroxy ester ether); a poly(hydroxybutyrate); a poly(anhydride); a polycarbonate; a poly(orthoester); a poly(amino acid); a poly(ethylene oxide); a poly(phosphazene); a poly ether ester; a polyester amides; a polyamide; and copolymers or blends of any of these degradable polymers.

10. The method of claim 8 wherein the dehydrated salt comprises a dehydrated salt chosen from the group consisting of: a particulate solid anhydrous borate material; anhydrous sodium tetraborate; anhydrous boric acid; and combinations thereof.

11. The method of claim 8 wherein the degradable particulate are made at the drill site.

12. The method of claim 8 wherein the degradable particulate is placed in the subterranean formation for use as a fluid loss control particle, a diverting agent, a filter cake component, a drilling fluid additive, a cement composition additive, a fracturing fluid additive, a gravel pack additive, or an acid-precursor component.

13. A method of controlling the degradation of a degradable polymer matrix comprising:
providing at least a plurality of degradable particulates, at least one of which comprising a degradable polymer matrix comprising a degradable polymer and having a first degradation rate;
incorporating a dehydrated salt into the degradable polymer matrix; and
allowing the salt to interact with a water source neighboring the degradable polymer matrix in such a manner as to allow the degradable polymer matrix to degrade at a second degradation rate that is slower than the first degradation rate of the degradable particulate.

14. The method of claim 13 wherein the degradable polymer comprises a degradable polymer chosen from the group consisting of: an aliphatic polyester; a poly(lactide); a poly(glycolide); a poly(ε-caprolactone); a poly(hydroxy ester ether); a poly(hydroxybutyrate); a poly(anhydride); a polycarbonate; a poly(orthoester); a poly(amino acid); a poly(ethylene oxide); a poly(phosphazene); a poly ether ester; a polyester amides; a polyamide; and copolymers or blends of any of these degradable polymers.

15. The method of claim 13 wherein the degradable polymer matrix comprises a plasticizer.

16. The method of claim 13 wherein the dehydrated salt comprises a dehydrated salt chosen from the group consisting of: a particulate solid anhydrous borate material; anhydrous sodium tetraborate; anhydrous boric acid; and combinations thereof.

17. The method of claim 13 wherein the degradable particulate is made at the drill site.

18. The method of claim 13 further comprising placing the degradable particulates into a subterranean formation.

19. The method of claim 19 wherein the degradable particulate is placed in the subterranean formation for use as a fluid loss control particle, a diverting agent, a filter cake component, a drilling fluid additive, a cement composition additive, a fracturing fluid additive, a gravel pack additive, or an acid-precursor component.

20. A degradable particulate for use in a subterranean formation comprising a degradable polymer matrix and a dehydrated salt.
